(19) United States
(12) Patent Application Publication
(10) Pub. No.: US 2013/0132145 A1
(43) Pub. Date: May 23, 2013

(54) COMPUTER-BASED SYSTEMS AND METHODS FOR OPTIMIZING MEETING SCHEDULES

(71) Applicant: Morgan Stanley & Co. LLC, New York, NY (US)

(72) Inventors: Barry S. Hurewitz, New York, NY (US); Omar Moustafa, Brooklyn, NY (US)

(73) Assignee: Morgan Stanley & Co. LLC, New York, NY (US)

(21) Appl. No.: 13/679,020

(22) Filed: Nov. 16, 2012

Related U.S. Application Data
(60) Provisional application No. 61/560,989, filed on Nov. 17, 2011.

(51) Int. Cl. G06Q 10/10

(52) U.S. Cl. CPC G06Q 10/1095
USPC 705/7.19

(57) ABSTRACT

Computer-based systems and methods that optimize meeting schedules based on financial score metrics. The meetings may be optimized for, for example, research analysts that are conducting in-person meetings with contacts of a research department and/or corporate executives of a company who, along with an analyst, are meeting contacts of the research department.

### PRIORITY CLAIM

This application claims priority to U.S. provisional patent application Ser. No. 61/560,989, entitled “COMPUTER-BASED SYSTEMS AND METHODS FOR OPTIMIZING MEETING SCHEDULES,” filed Nov. 17, 2011, which is incorporated herein by reference in its entirety.

### BACKGROUND

In the securities research industry, so called “sell-side firms” provide, among other things, research regarding securities (such as stocks or bonds) to, among others, so-called “buy-side firms,” which are typically institutional investors such as mutual funds, hedge funds, pension funds, etc. Particularly for equity research, sell-side firms typically employ a number of analyst teams that analyze and publish research reports about equity securities for publicly-traded companies in different industry sectors and/or geographic regions. For example, a sell-side firm may have a North America pharmaceuticals research team that analyzes North American publicly-traded pharmaceutical companies, a North America oil services research team that analyzes North American publicly-traded oil services companies, a North America semiconductors research team that analyzes publicly-traded companies that make and sell semiconductor products, and so on. The sell-side firm might also have corresponding European and/or Asian research analyst teams.

The analyst teams typically include a primary analyst and several research associates, though some teams may have other positions as well. These research teams generate numerous different types of research touch points for consumers of the research (e.g., the buy-side firms). The research touch points may include research reports (e.g., published electronic or hard copy reports), one-to-one telephone calls or meetings with contacts at the buy-side firms, tailored or blast emails and voicemails to such contacts, and/or other events such as seminars, conferences, corporate road shows, and meetings with corporate management.

A sell-side firm also typically employs salespeople who facilitate the distribution of the work product of the various research teams to appropriate contacts at the buy-side firms. The contacts typically are associated with one or more investment funds or accounts of the buy-side firm. A salesperson typically has contacts at many different buy-side firms, and those contacts may be interested in research work product from many different analyst teams at the sell-side firm. One role of a sell-side salesperson is to alert and distribute to his/her contacts work product from the various sell-side analyst teams.

### SUMMARY

In one general aspect, the present invention is directed to computer-based systems and methods that optimize meeting schedules based on financial score metrics. The meetings may be optimized for, for example, research analysts that are conducting in-person meetings with contacts of a research department and/or corporate executives of a company who, along with an analyst, are meeting contacts of the research department.

These and other aspects of the present invention are described below.

### FIGURES

Various embodiments of the present invention are described herein by way of example in conjunction with the following figures, wherein:

FIG. 1 is block diagram of a computer system according to various embodiments of the present invention;

FIG. 2 is one embodiment of an optimized list of meetings for an analyst in various geographic locations;

FIG. 3 is a chart illustrating one embodiment of a process flow for generating the list shown in FIG. 2;

FIG. 4 is one embodiment of a rank ordered list identifying contacts to schedule a meeting with representative(s) of a corporation; and

FIGS. 5 and 6 are diagrams of process flows for computing contact interest scores according to various embodiments of the present invention.

### DESCRIPTION

Various embodiments of computer-based systems and methods of the present invention are described below. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and illustrative. Variations and changes thereto may be made without departing from the scope of the claims.

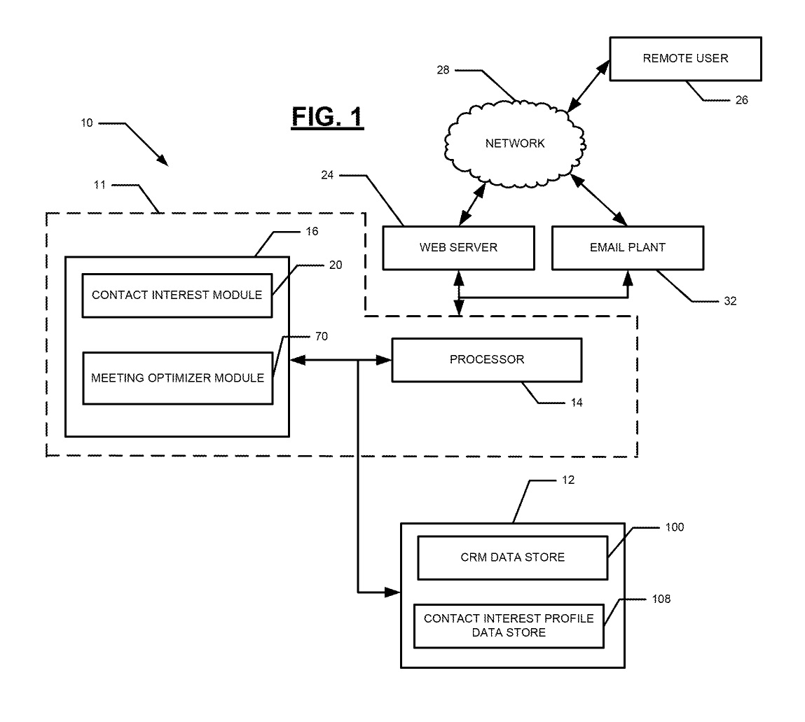

FIG. 1 is a diagram of a computer-based system 10 according to various embodiments of the present invention. The computer-based system 10 may comprise one or more networked, electronic computer devices 11, such as servers, personal computers, workstations, mainframes, laptops, and/or handheld computing devices. As shown in FIG. 1, the system 10 may comprise a computer-based data storage system 12, one or more processor circuits 14, and one or more memory units 16. For convenience, only one processor circuit (referred to hereinafter simply as “processor”) 14 and one memory unit 16 are shown in FIG. 1, although it should be recognized that the computer system 10 may comprise multiple processors and/or multiple memory units 16. The memory 16 may store a number of software modules, such as the modules as shown in FIG. 1. The modules may comprise software code that is executed by the processor 14, which execution causes the processor 14 to perform various actions dictated by the software code of the various modules, as explained further below. The processor 14 may have one or multiple cores. The memory 16 may comprise primary computer memory, such as a read only memory (ROM) and/or a random access memory (e.g., a RAM). The memory could also comprise secondary computer memory, such as magnetic or optical disk drives or flash memory, for example.

The data storage system 12 may comprise a number of data stores, which may be implemented as computer databases, data files, directories, or any other suitable system for storing data for use by computers. The data storage system 12 may be embodied as solid state memory (e.g., ROM), hard disk drive systems, RAID, disk arrays, storage area networks (SANs), and/or any other suitable system for storing computer data. In addition, the data storage system 12 may comprise caches, including web caches and database caches.

Embodiments of the present invention are described herein in the context of a sell-side equity research department that provides research work product to contacts at buy-side firms, where the equity research department comprises, among other things, multiple analyst teams that cover different industry sectors and/or geographic regions, and salespeople with contacts at the sell-side firms. It should be noted that the analyst teams preferably also have contacts at the buy-side firms. In addition, different salespeople and/or analysts may have one or more common contacts at a buy-side firm. The collective contacts of the various salespeople and analyst teams of the equity research department are sometimes referred to herein as contacts of the equity research department.

While embodiments and aspects of the present invention are described herein in the context of a sell-side equity research department, it should be noted that the embodiments and aspects of the present invention are not necessarily limited to sell-side equity research departments unless specifically noted, and that embodiments or aspects of the present invention described herein may be applicable to industries other than sell-side equity research departments, such as fixed-income research departments, other types of research departments that produce research work product that is consumed by clients or customers of the research department, or applicable to any organization or enterprise with customers, clients or contacts, for example.

As shown in FIG. 1, the computer system 10 may comprise: (i) a contact interest profile module 20 that determines likely interests of the contacts of the equity research department; and (ii) a meeting optimizer module 70 that, for example, optimizes meeting schedules for members of the analyst teams, such as a primary analyst, or meetings between an executive(s) of a publicly-traded company and buy-side contacts, which meetings are facilitated and/or arranged by the sell-side equity research department.

The data storage system 12 may comprise, for example, a customer relationship management (CRM) data store 100 and a contact interest profile data store 108. The CRM data store 100 may store data regarding the contacts of the equity research department, including contact information for the contacts (email addresses, mailing addresses, phone numbers, etc.) in addition to data regarding interaction between the various contacts and members of the sell-side equity research department, such as emails, phone calls, and meetings involving the various contacts and members of the equity research department. The contact interest profile data store 108 may store the interest profiles of the contacts determined by the contact interest profile module 20. More details regarding such data stores may be found in the following patent documents that are incorporated herein by reference in their entirety: U.S. Pat. No. 7,734,517; U.S. Pat. No. 7,689,490; U.S. Pat. No. 7,769,654; U.S. published patent application Pub. No. 2010/0290603; and WO 2007/038587 A2.

The computer system 10 may also include one or more web servers 24 in communication with the computer 11. The web server 24 may host web sites accessible by a remote user 26, via an electronic data communication network 28. The network 28 may comprise one or more LANs, WANs, the Internet, and/or an extranet, or any other suitable data communication network allowing communication between computer systems. The network 28 may comprise wired and/or wireless links. The computer system 10 may also comprise a computer-based email plant 32. The computer-based email plant 32 may be implemented as one or more computer servers that handle the email protocol for the organization or enterprise associated with the computer system 10. The email plant 32 may facilitate the sending and receiving of internal and external emails via the computer data network 28.

A typical sell-side global equity research department may include hundreds of analyst teams worldwide, such as 100-300 different worldwide analyst teams. The various analyst teams may collectively cover numerous (e.g., thousands, such as 5000 or more) stocks that are publicly traded on stock exchanges worldwide (such as North American exchanges, (e.g., the New York Stock Exchange and NASDAQ), European exchanges (e.g., the London Stock Exchange and Euronext), Asian exchanges (e.g., Tokyo and Shanghai stock exchanges), etc.). Such publicly-traded stocks are commonly referred to, and are sometimes referred to herein, as “tickers” because each publicly traded stock is ordinarily associated with a ticker symbol. In addition, the various analyst teams in an equity research department collectively generate numerous research work products every business day (e.g., trading days of the various exchanges). For example, the various analyst teams in an equity research department may collectively generate 100 to 200 research reports or other work product in a given business day, at various times throughout the business day, but ordinarily concentrated around the opening of the local stock exchange. A typical global equity research department also has numerous buy-side contacts (e.g., 5000 or so buy-side contacts) associated with various investment funds or accounts.

Before describing exemplary operations of the meeting optimizer module 70, a description of the contact interest profile module 20 is provided. The contact interest profile module 20 may compute team and ticker interest scores for each contact. The subject contact's ticker interest scores may be computed mathematically based on the contact's readership and interaction scores for the tickers. For example, the subject contact's ticker interest scores may be a weighted average of the subject contact's readership and interaction scores for the tickers. Similarly, the subject contact's team interest scores may be computed mathematically based on the subject contact's readership, interaction and/or broker vote scores for the teams. For example, the subject contact's team interest scores may be a weighted average of the subject contact's readership, interaction and broker vote scores for the teams. These scores for each contact may be stored in the contact interest profile data store 108. The scores may be scaled so that they are within a desired range, such as 0 to 100 for example, or some other desired range.

The interest scores, which may be stored in the contact interest profile data store 108, may include, for example, (i) team scores that indicate a particular contact's interest in the various analyst teams of the equity research department, and (ii) ticker scores that indicate a particular contact's interest in various tickers covered by the analyst teams. The contact interest scores may be determined based on CRM data stored in the CRM data store 21 and/or any other relevant data. The CRM data may generally indicate the contact's interacts with the equity research department regarding particular tickers and analysts teams. For example, the CRM data may indicate what research work product the contact read or otherwise accessed, which analyst teams the contact talked with on the phone or in meetings, the topics (e.g., tickers) that were the subject of such calls or meetings, etc. Whether a document (e.g., research document generated by an analyst team of the equity research department) has been read or otherwise accessed by a contact can be determined based on whether the contact downloaded the document, such as via the internet or some other electronic data communication network, from an electronic research work product repository of the equity research group. The contact may be, for example, required to input credentials (e.g., ID and password) or use a personalized hyperlink to access work product for downloading, thereby indicating which contacts downloaded or otherwise accessed which research work product. The interest scores may be updated from time to time or periodically based on updated data. For example, the contact interest scores may be updated daily, weekly, monthly, quarterly, annually, or at some other frequency that is acceptable and practical for the particular equity research department.

One or more of various mathematical models may be used by the contact interest profile module 20 to generate the contact interest scores. When multiple models are used, the results from each model may be stored and reported separately, so that a user can see how the results are different for different models. In addition or alternatively, when multiple models are used, the resulting interest profile may be a combination of the results from the multiple models (e.g., an average of the scores from the different models that are used). For example, a scoring model and/or a propensity model could be used that determine, for example, (i) readership scores by topic (e.g., ticker) and/or analyst team for each contact, (ii) interaction scores by ticker and/or analyst team for each contact, and/or (iii) broker vote scores by analyst team for each contact that cases broker votes. The ticker readership and/or interaction scores may be used to generate the ticker interest scores for the contact. The team readership, interaction, and/or broker vote scores may be used to generate the team interest scores. More details about such scoring and propensity models may be found in U.S. patent application Ser. No. 13/402,998, entitled “COMPUTER-BASED SYSTEMS AND METHODS FOR DETERMINING INTEREST LEVELS OF CONSUMERS IN RESEARCH WORK PRODUCT PRODUCED BY A RESEARCH DEPARTMENT,” filed Feb. 23, 2012, which is incorporated herein by reference in its entirety.

The following is an explanation of broker votes. Often equity research resources generated by the sell-side firm are provided to various buy-side firms and accounts without direct charge. Instead, buy-side firms compensate the sell-side firm for research by utilizing the brokerage services of the sell-side firm to execute trades. The price paid by the buy-side firm for trade execution is intended to compensate the sell-side firm for brokerage services as well as for any equity research resources consumed by the buy-side firm. Accordingly, buy-side firms typically direct their trade execution business to sell-side firms that provide valuable equity research. One common method utilized by buy-side firms is a broker vote. According to a typical broker vote process, a buy-side firm polls its research consumers (typically including contacts at the buy-side firm of the sell-side firm) to identify the sell-side firm or firms that provide research valued by the research consumers. Research consumers may be any buy-side firm personnel who consume equity research, such as fund managers in the buy-side firm and/or their analyst teams. In some embodiments, broker votes may be limited to personnel that make trading decisions based on equity research. The buy-side firm then selects sell-side firms for execution services based on the results of the vote. The broker vote itself may be structured in any suitable fashion. For example, in one embodiment, participating equity research consumers at a buy-side firm rank analysts or analyst teams from different sell-side firms across various, different market sectors, where a first place vote is worth 10 points, a second place is worth 5 points, and a third place vote is worth 3 points. If the total number of points available is from all participating equity research consumers at the buy-side firm is N, and if sell-side firm A received x% of the N available points, then the buy-side firm would direct x% of its trade execution to sell-side firm A in an upcoming time period (e.g., the next calendar quarter or some other period). This process could be repeated periodically, such as every quarter, semi-annually, or annually, for example.

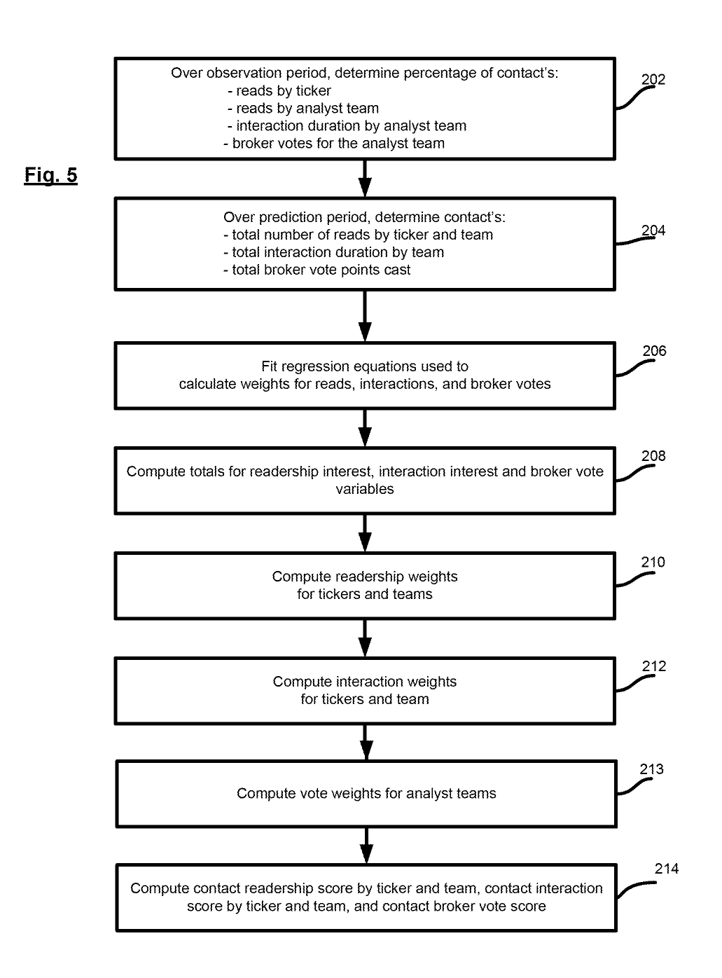

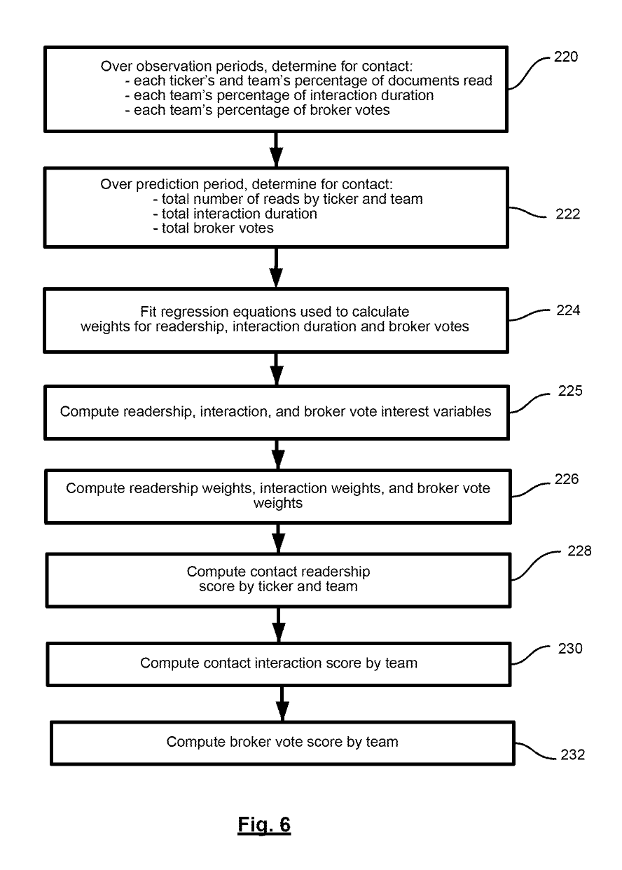

FIGS. 5 and 6 are flowcharts of example processes that may be performed by the processor 14 of the computer system 10 to compute such (i) topic/ticker and team readership scores, (ii) ticker and team interaction scores, and/or (iii) broker vote scores when executing the code of the contact interest model 20. The FIG. 5 embodiment is a contact-centric scoring model and the embodiment of FIG. 6 is a document-centric scoring model. In other embodiments, just the ticker/team readership scores could be computed or just the interaction scores could be computed or just the broker vote scores could be computed, or some combination of those scores could be computed. In addition or alternatively, readership and interaction scores could be computed based on parameters other than ticker or analyst team, such as by industry, market or sector (such as industries, markets or sectors defined by the Global Industry Classification Standard (GICS) or the Industry Classification Benchmark (ICB)).

The scoring model embodiments of FIGS. 5 and 6 utilize both so-called observation and prediction periods, that are both referenced to a recommendation period. The recommendation period may be the time period during which the equity research department is determining which research work product to recommend to its contacts. As such, the recommendation period may be the current day. The observation and prediction periods may be time periods that comprise one or more past (or historical) time period units, preferably for which contact interaction data (e.g., documents reads, phone calls, etc.) is available. For example, the prediction period could be Nₚ time period units prior to a current time period, and the observation period may be Nₒ time period units prior to the current time period. In various embodiments, a time period unit is one month, although other time period units may be used. In various embodiments, the prediction period could be one time period unit (e.g., one month) before the recommendation period (Nₚ=1), and the observation period is two to four time period units (e.g., two to four months) before the recommendation period (Nₒ=2 or Nₒ=4).

The processes of FIGS. 5 and 6 illustrate example processes for one contact (“the subject contact”). The computer system 10 may execute one or both of the processes for multiple (and preferably all) contacts of the equity research department periodically or from time-to-time (e.g., every business day, every week, etc). The process of FIG. 5 starts at step 202 where, for example, over the observation, the percentage of the subject contact's percentage of reads by ticker and analyst team are computed, as well as the subject contact's percentage of interaction duration with each analyst team. These computations may be performed based on data stored in the CRM data store 100. For example, if the subject contact read one hundred (100) research documents over the observation period, and if thirty of the ones the subject read over the observation period pertained to a particular ticker (say ticker ABC, for the sake of example), the subject contact's percentage of reads for ticker ABC would be 30% (or 0.30); if the contact read twenty five (25) reports on ABC, the contact's percentage would be 25% (or 0.25), and so on. Similarly, if forty (40) of the documents that the subject contact read over the observation period were generated by a particular analyst team (say analyst team number 111, for the sake of example), the subject contact percentage's of reads for analyst team 111 would be 40% (or 0.40); if the contact read thirty-five (35) from analyst team 111, the subject contact's percentage would be 35% (or 0.35) for analyst team 111, and so on. For the contact's interaction duration percentage for analyst team 111, the total duration of phone calls between analyst team 111 and the contact during the observation period could be divided by the cumulative duration of all calls that the client had with all analyst teams. For example, if the contact's call duration for the observation period with analyst team 111 was fifteen (15) minutes, and the cumulative duration of all calls that the client had with all analyst teams during the observation period was seventy-five (75) minutes, the contact's interaction duration percentage for analyst team 111 would be 20% (or 0.20). At step 202 the computer system 10 may also compute the percentage of the subject contact's broker votes given to particular analyst teams of the equity research department over the observation period.

In the context of step 202 of FIG. 5, a subject contact's broker vote score for a given analyst team may be computed by determining the percentage of the subject contact's total broker vote points that the subject contact awarded during the observation period to the given analyst team. For example, if the subject contact awarded 40% of his/her total broker vote points to analyst team 111, the contact's broker vote score for analyst team 111 would be 0.40. The subject contact's broker vote score for each analyst team may be computed in a similar manner. Broker vote data may be stored in the CRM data store 100

At step 204, the subject contact's total number of reads by ticker and team over the prediction period are determined based on, for example, the CRM data, as well as the total interaction duration of the subject contact for each respective analyst team. Also at step 204, in embodiments where broker votes are used to determine the subject contact's interest profile, the total number of broker votes cast by the subject contact over the prediction period are determined, based on, for example, broker vote data in the CRM data store 100.

Next, at step 206, regression equations to be used to calculate ticker, team and broker vote weights for readership and interactions may be fit. For example, for tickers or teams, the percentage of all of the subject contact's reads for all tickers or teams determined at step 202 may be denoted as X, and the total number of reads for all tickers or teams determined at step 204 may be denoted as Y, the following equation may be solved:

Y=β_{read}X

where β_{read} is coefficient for estimating the linear relationship between ticker or team reads (Y) and the percentage of ticker or team reads (X). Similarly, all percentages of subject contact interaction durations with some team determined at step 202 may be denoted as X, and all interaction durations with some team determined at step 204 may be denoted as Y, the following equation may be solved:

Y=β_{interaction} x

where β_{interaction} is team regression coefficient for estimating the linear relationship between team interactions (Y) and the percentage of team interactions (X). In a similar manner, the a regression coefficient for broker votes could be determined at step 206 (e.g., Y=βᵥₒₜₑX).

Next, at step 208, the total beta ratio for the readership and interaction variables are determined. In one embodiment, the total beta ratio for readership may be computed as:

$$\frac{1}{{β}_{read , ticker}} + \frac{1}{{β}_{read , team}} = {β}_{read , total}$$

The total beta ratio for the interaction variable may be computed as:

$$\frac{1}{{β}_{interact , ticker}} {β}_{interact , total}$$

For embodiments where broker votes are used, beta ratios for the broker vote variable may be determined as step 208 (e.g.,

$$\frac{1}{{β}_{vote , team}} = {β}_{vote , total} ) .$$

Next, at step 210, the readership weights (W) may be computed for all teams and tickers, where, in one embodiment:

$${W}_{read , ticker} = \frac{( 1 / {β}_{read , ticker} )}{{β}_{read , total}}$$

$${W}_{read , team} = \frac{( 1 / {β}_{read , team} )}{{β}_{read , total}}$$

Next, at step 212, the interaction weights (W) may be computed for all teams, where, in one embodiment:

$${W}_{read , team} = \frac{( 1 / {β}_{interact , team} )}{{β}_{interact , total}}$$

Next, at step 213, broker vote weights per team (W_{brokervote,team}) may be computed. In one embodiment, the broker vote weights by team may be computed as:

$${W}_{vote . team} = \frac{( 1 / {β}_{vote , team} )}{{β}_{vote , total}}$$

Next, at step 214, the subject contact's readership scores by ticker and team are computed. In one embodiment, the subject contact's readership scores may be determined based on at least (i) the subject contact's percentage of reads by ticker and team determined at step 202 and (ii) the readership weight by team or ticker determined at step 210. For example, in one embodiment, the subject contact's readership score may be determined based on a product of (i) the subject contact's percentage of reads by ticker and team determined at step 202 and (ii) the readership weight by team or ticker. For example, if the subject contact's percentage of reads for ticker ABC was 80% and the readership weight for tickers was 0.20, then the subject contact's readership score for ticker ABC would be 0.16. In a similar manner, the subject contact's readership score for each ticker and team could be computed.

Also at step 214, the subject contact's interaction scores by team are computed. In one embodiment, the subject contact's interaction scores may be determined based on at least (i) the subject contact's percentage of interaction duration by team determined at step 202 and (ii) the subject contact's interaction weight by team determined at step 212. For example, in one embodiment, the subject contact's readership score may be determined based on a product of (i) the subject contact's percentage of interaction duration by team determined at step 202 and (ii) the team interaction weight determined at step 212. In a similar manner, the subject contact's interaction score for each analyst team could be computed. Also at step 214, the subject contact's broker vote scores by team may be computed. In one embodiment, the subject contact's broker votes scores may be determined based on at least (i) the subject contact's percentage of broker vote by team determined at step 202 and (ii) the subject contact's broker vote weight by team determined at step 213. The subject contact's contact profile may comprise the collection of (i) the subject contact's readership scores by team and/or ticker, (ii) the subject contact's interaction score by ticker and team, and/or (iii) the subject contact's broker vote score by teams. The scores for the subject contact's interest profile may be stored in the contact interest profile data store 108. In a similar manner, the interest profiles for the other contacts of the equity research department may be computed and stored.

FIG. 6 illustrates another process flow for determining a subject contact's ticker/team readership and interaction scores, as well as the broker vote sores, according to various embodiments. At step 220, over the observation period, each ticker's and team's percentage of documents read by the subject contact is determined. For example, if ten documents were generated by the equity research department pertaining to a particular ticker (say ticker ABC, for the sake of example), and if the subject contact read all ten of them, the contact's percentage of reads for ticker ABC would be 100% (or 1.00); if the contact read nine of them, the contact's percentage would be 90% (or 0.90), and so on. If a particular analyst team (say analyst team number 111, for the sake of example) produced twenty documents during the observation period, and the contact read all twenty of them, the contact percentage's of reads for analyst team 111 would be 100% (or 1.00); if the contact read nineteen of them, the contact's percentage would be 95% (or 0.95), and so on. Also at step 220, the subject contact's percentage of interaction duration for each team is determined. For example, for the subject contact's interaction duration percentage for analyst team 111, the total duration of phone calls between analyst team 111 and the subject contact during the observation period could be divided by the cumulative duration of all calls that the subject contact had with all analyst teams over the observation period. Also at step 220, the each analyst team's percentage of the broker vote points cast by the subject contact are determined.

Next, at step 222, the total number of reads by the subject contact over the prediction period by ticker and team is determined. In addition, the total interaction duration by team by the subject contact over the prediction period is determined. In addition, the total number of broker votes by the subject contact over the prediction period is determined. Next, at step 224, regression equations used to calculate weights for readership, interaction, and broker votes are fit. This may be similarly to step 206 of FIG. 5. Next, at step 225, readership, interaction and broker vote interest regression coefficients may be computed for ticker and team. This may be similarly to step 208 of FIG. 5. Next, at step 226, readership weights, interaction weights, and broker vote weights may be computed for ticker and team, as the case may be. This may be similarly to steps 210-213 of FIG. 5. Next, at step 228, the subject contact's readership scores by ticker and team may be computed. This may be similarly to step 214 of FIG. 5. Next, at step 230, the subject contact's interaction scores by team may be computed. This may be similarly to step 214 of FIG. 5. Next, at step 232, the subject contact's broker vote scores by team may be computed. This may be similarly to step 214 of FIG. 5.

In various embodiments, certain constraints may be placed on the interest regression coefficients and/or weights. For example, in one embodiment, all interest regression coefficients β must be positive and all weights W must also be positive. Another preferable constraint is that W_{read sticker}>W_{readteam} . In addition, in various embodiments, the contact interest profile module 20 may compute validity parameters, such as hit rates for individual contacts. One possible hit rate is the ratio of the number of recommended documents read by a contact to the total number of documents recommended to the contact. The contact's interest profile may be adjusted based on such validity testing, with the adjusted interest profiles stored in the contact interest profile data store 108.

In various embodiments, the reads and/or interactions by the subject contact may be weighted based on time when determining the contact's interest profile. For example, more recent reads and/or interactions by the contact may be weighted more heavily than reads and/or interactions that were not recent. For example, reads and/or interactions that occurred within the last ninety (90) days may have a weighting factor of R, reads and/or interactions that occurred within ninety-one (91) to one hundred eighty (180) days may have a weighting factor of S, and reads and/or interactions that occurred more than one hundred eighty (180) days ago may have a weighting factor of T, where R>S>T. In other embodiments, different weighting factors and/or time bands may be used.

For each contact, the contact interest profile module 20 may compute a ticker interest score and a team interest score.

Attending meetings may consume a large percentage of an analyst's time. For example, in some environments, an analyst may spend more than 40% of their time meeting with contacts. In many cases, the meetings are held in various cities around the country or world, with the analyst only spending a limited amount of time in each city. Determining which contacts to schedule a meeting with in a particular city, especially when an analyst may have hundreds of different contacts to choose from, is a difficult task. Due to the limited number of contacts that an analyst can meet with in a single day, the inventors have determined that it is beneficial to process large amounts of data regarding the contacts and determine the most effective way for an analyst to spend their time while visiting a city. In one embodiment, the meeting optimizer module 70 (FIG. 1) is used to process various types of contact data to generate a list of top contacts for analyst meetings in a city based on who is interested in the analyst's research and/or based on various financial factors. As discussed in more detail below, the analyst may then seek to schedule meetings with the contacts identified by the meeting optimizer module 70. While the present disclosure is not limited to either analysts or teams of analysts, but instead could be applied in other contexts where an individual (or associated group) only has time for a limited number of meetings in a particular time frame (e.g., one day), for simplicity the disclosure will largely be described in the context of identifying accounts and contacts for individual analysts.

In one embodiment, the meeting optimizer module 70 first generates an analyst (or team) interest score for each contact within a geographic area. The geographic area may be a destination to which the analyst plans on traveling for meetings with contacts. The interest score may be based on any of the interest models described herein. In some embodiments, a contact's interest score is a weighted composite score based on team interactions (33%), team readership (33%), vote count (16.5%), and vote points (16.5%), although the present disclosure is not so limited and other factors and/or weightings could be used to compute the raw analyst interest scores for the contacts. Once a raw interest score is computed, each score may be scaled (e.g., scaled on a range from 1 to 100). In some embodiments, a minimum scaled score is needed for the contact to be considered during the optimization process. In one embodiment, the minimum scaled score is 30. In other words, the contact will not be targeted for a meeting with the analyst unless the contact is determined to have at least a threshold level of interest in that analyst.

For all contacts satisfying the threshold level of interest, the meeting optimizer module 70 may optimize the contacts based on financial score, for example. In one embodiment, the financial score is a weighted composite score based on opportunity (50%) and current value (50%) to the research department. In one embodiment the opportunity score is based on a combination of the contact's tier and revenue opportunity. The revenue opportunity for a contact helps to quantify the revenue upside for a contact. In one embodiment, the current value score is based on the account revenue per meeting for the contact. The revenue per meeting may be calculated on a nine month rolling basis, for example. The account revenue per meeting metric helps to ensure that one particular contact does not receive too many meeting to the detriment of other contacts in the area. The data associated with these metrics may be stored in the data storage system 12 (FIG. 1) and accessed by the meeting optimizer module 70. It should be noted that the metrics provided herein are merely exemplary, as other embodiments may use a wide variety of other metrics and/or factors to provide a scoring for individual contacts.

In one embodiment, the meeting optimizer module 70 is executed across all analyst teams, all accounts, and all contacts. The meeting optimizer module 70 may process the contact-related data to determine an optimized list of where to market (e.g., cities) and who to market to in each location (e.g., accounts and/or contacts). In one embodiment, the number of meetings per day in each city or geographic location is configurable. For example, an analyst may be able to attend up to six meetings in each location. Each meeting may be with a different account, with each account having at least one contact that satisfies the interest threshold for that analyst. In some embodiments, a ranked list of geographic locations may be generated by the meeting optimizer module 70. In some circumstances, the analyst may indicate which geographic location(s) they will be visiting and the meeting optimizer module 70 may generate a ranked list of accounts in that geographic area(s).

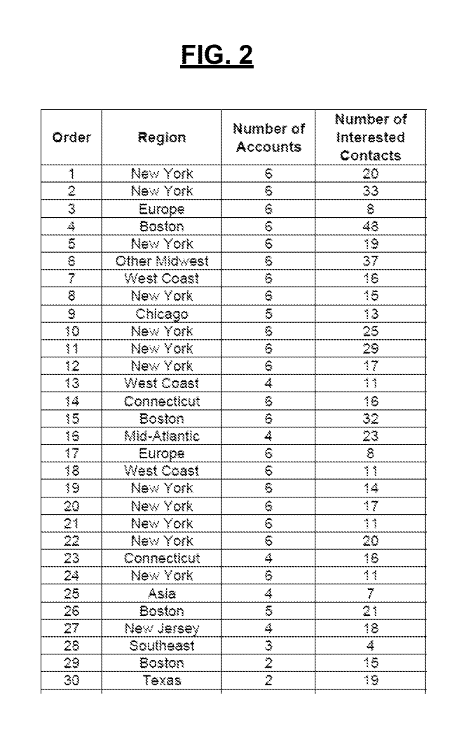

The optimized list generated by the meeting optimizer module 70 may optimize on the highest yield cities/regions based on interest and financial score. FIG. 2 illustrates an example of an optimized list 700 for a particular analyst in accordance with one non-limiting embodiment. Generally, the list 700 provides a summary of where the analyst should market based on a minimum threshold of interest and total financial score. The list 700 in FIG. 2 comprises an order (or rank) column 702, a region column 704, a number of accounts column 706, and a number of interested contacts column 708. As shown in the first two rows of FIG. 2, the meeting optimizer module 70 has determined that twelve accounts in the New York region top the list.

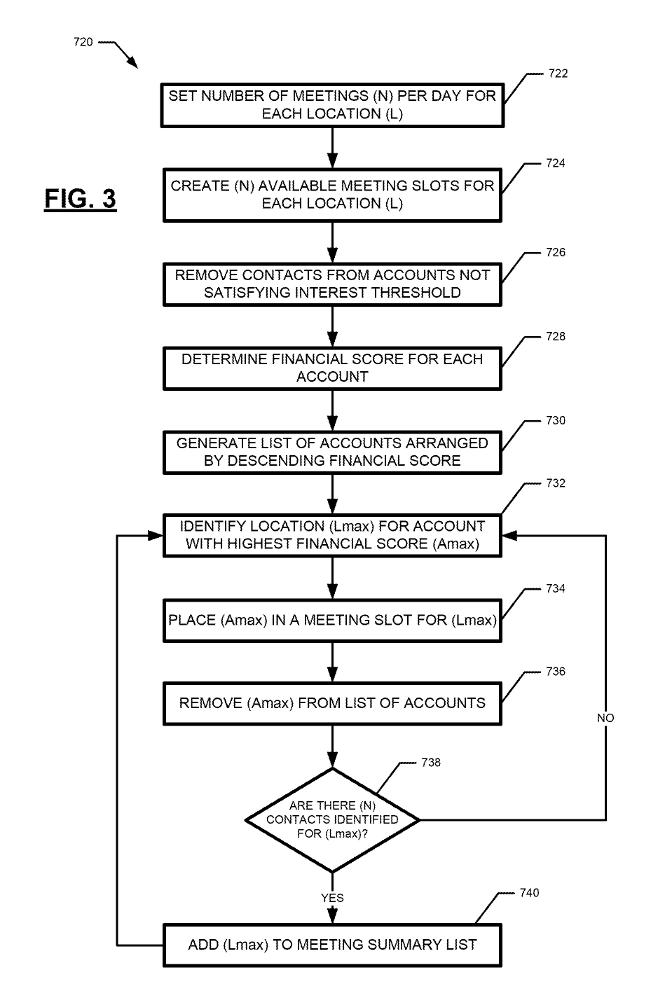

FIG. 3 is a process flow 720 illustrating how the list 700 was generated in accordance with one non-limiting embodiment. At 722, the number of meetings (N) per day for each location (L) is set. In one embodiment, N is set to a certain number (e.g., 6) for each location; in other embodiments, N may vary by location. At 724, the meeting optimizer module 70 creates N available meeting slots for each location. At 726, the meeting optimizer module 70 removes contacts from accounts that do not satisfy the interest threshold. At 728, the meeting optimizer module 70 determines the financial score for each account (e.g., based on a weighted composite score combining an opportunity score and a current value score). And at 730, the accounts are arranged in descending financial score such that the account with the highest financial is at the top of the list. At 732, the location (Lmax) associated with the account with the highest financial score (Amax) is identified. At 734, the meeting optimizer module 70 inserts that account into a meeting slot associated with the account's location. At 736, that account is removed from the list of accounts such that the account with the next-highest financial score is identified as Amax. At 738, the meeting optimizer module 70 determines if N accounts have been identified for Lmax in order to determine if there are any meeting slots available for that location. If there are not N accounts identified for Lmax, the process proceeds to identify the location Lmax of Amax at 732 (i.e., the location of the account with the next highest financial score). If there are N accounts identified (i.e., all of the meeting slots are filled for that location), the location is added to the optimized list 700.

As shown in FIG. 2, in the interested contacts column 708, once an account is added to the optimized list 700, each contact associated with the account that satisfies the interest threshold may be indicated as a potential target for a meeting. For example, in the first row, the six New York accounts have a combined total of 20 interested contacts. The meeting optimizer module 70 may provide a listing of those 20 interested contacts so that the analyst can determine the best course of action for meeting with one or more of those contacts. For example, it may be desirable to have one meeting at each account that is attended by multiple contacts. Alternatively, the analyst may wish to meet with contacts at an account individually. In any event, the meeting optimizer module 70 processes the data to identify the accounts and/or contacts that the analyst should target.

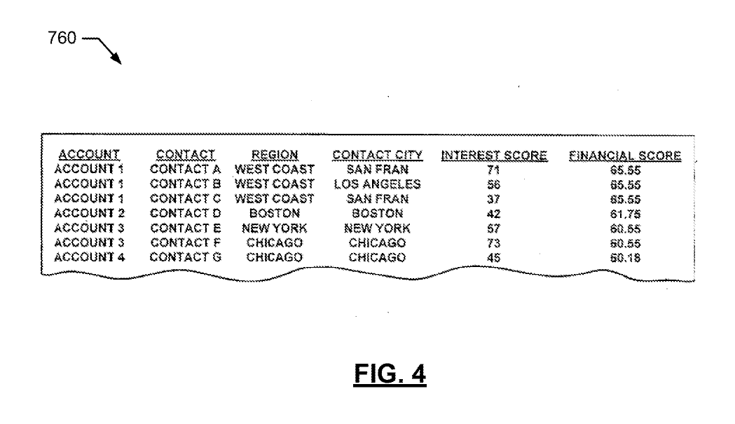

In addition to analysts meeting with contacts, in some situations representatives of a corporation (e.g., a publicly traded corporation or a corporation about to go public) may want to meet directly with the analyst's contacts (i.e., investors). For example, one or more representatives of a corporation may travel to various geographic locations with an analyst to meet with one or more contacts in the area. Typically, the corporation would be in an industry sector covered by the analyst. The meeting optimizer module 70 may be used to identify contacts who would likely be interested in meeting with a representative(s) of the corporation. First, the meeting optimize module 70 may use any of the interest models discussed herein to identify contacts that are interested in the analyst and/or ticker. For example, in one embodiment, the interest score may be based on a combination of team interaction data, team readership data, vote count data, and/or vote points data. Next, the meeting optimizer module 70 may employ one or more amplifiers to further differentiate the contacts in order to create a rank ordered list of identified contacts. In one embodiment, the meeting optimizer module 70 analyzes the holdings of the funds associated with each contact to ascertain which contact-associated funds own stock of the representative's corporation. This holdings data may be culled from FACTSET or any other suitable source and stored in the data store 12. The meeting optimizer module 70 may also using trading data stored in the data store 12 to identify contact-associated funds that are actively trading holdings related to the corporation. Additionally, since articles published by researchers are often tied to a particular corporation, the meeting optimizer module 70 may use the ticker readership data or scores to link contacts to particular corporations. In one embodiment, using the above-mentioned data, the meeting optimizer module 70 may generate a rank ordered list 760 (FIG. 4) identifying contacts to schedule a meeting with the representative(s) of the corporation. As shown in the example of FIG. 4, the meeting optimizer module 70 has determined that the analyst and representative of the corporation should first target Contact A of Account 1 in San Francisco; that Contact B of Account 1 should be targeted in Los Angeles, and so forth. The list 760 is merely representative of one embodiment; in other embodiments a wide assortment of other data may be included in the list, such as the contact's role, the account's tier, the number of interaction minutes, for example.

It will be apparent to one of ordinary skill in the art that at least some of the embodiments described herein may be implemented in many different embodiments of software, firmware, and/or hardware. The software and firmware code may be executed by a processor circuit or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A system for identifying contacts, the system comprising:
a computer-based data storage system that stores at least one financial score metric for each of a plurality of accounts of a financial services firm, wherein the financial score metric for an account is indicative of a financial value of the account to the financial services firm, and wherein each account is associated with at least one geographic location; and
a computer system in communication with the computer-based data storage system and comprising at least one processor and operatively associated memory, wherein the computer system is programmed to:
generate a ranked ordered list of accounts based at least on the financial score metrics for the accounts, wherein the ranked ordered lists is ordered from highest financial score metric to lowest financial score metric; and
allot an available number of meeting slots for in-person meetings in a geographic location to accounts associated with the geographic location from the ordered list of accounts starting with an account associated with the geographic location and having the highest financial score and continuing in order by financial score for accounts associated with the geographic location until the available number of meeting slots is filled.

2. The system for identifying contacts of claim 1, wherein the computer-based data storage system stores at least one contact metric for each of a plurality of contacts, wherein each contact is associated with an account.

3. The system of claim 2, wherein the computer system is programmed to identify contacts associated with each account allotted to the available number of meeting slots that satisfy a threshold based on the at least one contact metric.

4. The system for identifying contacts of claim 2, wherein the at least one contact metric is an interest score.

5. The system of identifying contacts of claim 4, wherein the interest score is based one at least one of interaction data, readership data, and voting data.

6. The system of identifying contacts of claim 5, wherein the interest score is a weighted composite score of two or more variables.

7. The system of identifying contacts of claim 6, wherein one of the two or more variables is a revenue opportunity value.

8. A computer-implemented method for identifying contacts, the method comprising:
storing, by a computer system, at least one financial score metric for each of a plurality of accounts of a financial services firm, wherein the financial score metric for an account is indicative of a financial value of the account to the financial services firm, and wherein each account is associated with at least one geographic location;
generating, by the computer system, a ranked ordered list of accounts based at least on the financial score metrics for the accounts, wherein the ranked ordered lists is ordered from highest financial score metric to lowest financial score metric; and
allotting, by the computer system, an available number of meeting slots for in-person meetings in a geographic location to accounts associated with the geographic location from the ordered list of accounts starting with an account associated with the geographic location and having the highest financial score and continuing in order by financial score for accounts associated with the geographic location until the available number of meeting slots is filled.

9. The method for identifying contacts of claim 8, comprising storing at least one contact metric for each of a plurality of contacts, wherein each contact is associated with an account.

10. The method for identifying contacts of claim 9, comprising identifying contacts associated with each account allotted to the available number of meeting slots that satisfy a threshold based on the at least one contact metric.

11. The method of identifying contacts of claim 10, wherein the at least one contact metric is an interest score.

12. The method of identifying contacts of claim 11, wherein the interest score is based one at least one of interaction data, readership data, and voting data.

13. The method of identifying contacts of claim 12, wherein the interest score is a weighted composite score of two or more variables.

14. The method of identifying contacts of claim 13, wherein one of the two or more variables is a revenue opportunity value.

15. A computer-readable medium having stored thereon instructions, which when executed by a processor cause the processor to identify contacts by:
generating a ranked ordered list of accounts based at least on a financial score metric for each of a plurality of accounts, wherein the financial score metric for an account is indicative of a financial value of the account to the financial services firm, and wherein each account is associated with at least one geographic location, and wherein the ranked ordered list is ordered from highest financial score metric to lowest financial score metric; and
allotting an available number of meeting slots for in-person meetings in a geographic location to accounts associated with the geographic location from the ordered list of accounts starting with an account associated with the geographic location and having the highest financial score and continuing in order by financial score for accounts associated with the geographic location until the available number of meeting slots is filled.

16. The computer-readable medium of claim 15, wherein there is at least one contact metric for each of a plurality of contacts, wherein each contact is associated with an account.

17. The computer-readable medium of claim 16, wherein the instructions when executed by a processor cause the processor to identify contacts associated with each account allotted to the available number of meeting slots that satisfy a threshold based on the at least one contact metric.

18. The computer-readable medium of claim 17, wherein the at least one contact metric is an interest score.

19. The computer-readable medium of claim 18, wherein the interest score is based one at least one of interaction data, readership data, and voting data.

20. The computer-readable medium of claim 18, wherein the interest score is a weighted composite score of two or more variables.

21. The computer-readable medium of claim 20, wherein one of the two or more variables is a revenue opportunity value.
